(19) United States
(12) Patent Application Publication
(10) Pub. No.: US 2004/0242451 A1
(43) Pub. Date: Dec. 2, 2004

(54) Cleaning formulation for optical surfaces

(75) Inventors: Howard A. Ketelson, Fort Worth, TX (US); Michael A. Brook, Ancaster (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: Trojan Technologies Inc.

(21) Appl. No.: 10/648,444

(22) Filed: Aug. 27, 2003

Related U.S. Application Data
(63) Continuation of application No. 09/864,195, filed on May 25, 2001, now abandoned.
(60) Provisional application No. 60/207,187, filed on May 26, 2000.

(51) Int. Cl. C11D 3/02

(52) U.S. Cl. 510/510

(57) ABSTRACT

A cleaning formulation for removing materials from a surface (e.g., an optical surface, a metal surface and the like), the cleaning formulation comprising from about 0.5 to about 60 weight percent of a compound derived from urea and a phosphorus-containing acid, together with a carrier therefor. A method for removing fouling materials from a surface is also described. The cleaning formulation may be used to remove materials, inter alia, from optical radiation surfaces, optical lens surfaces (e.g., a contact lens) and the like.

### CROSS-REFERENCE TO RELATED APPLICATION

The present application claims the benefit under 35 U.S.C. §119(e) of provisional patent application Ser. No. 60/207,187, filed May 26, 2000, the contents of which are hereby incorporated by reference.

### BACKGROUND OF THE INVENTION

1. Field of the Invention

In one of its aspects, the present invention relates to a cleaning formulation for, inter alia, optical surfaces. In another of its aspects, the present invention relates to a method for removing fouling materials, inter alia, from an optical surface.

2. Description of the Prior Art

Fluid treatment systems are known generally in the art.

For example, U.S. Pat. Nos. 4,482,809, 4,872,980 and 5,006,244 (all in the name of Maarschalkerweerd and all assigned to the assignee of the present invention and hereinafter referred to as the Maarschalkerweerd #1 Patents) all describe gravity fed fluid treatment systems which employ ultraviolet (UV) radiation.

Such systems include an array of UV lamp frames which include several UV lamps each of which are mounted within sleeves which extend between and are supported by a pair of legs that are attached to a cross-piece. The so-supported sleeves (containing the UV lamps) are immersed into a fluid to be treated, which is then irradiated as required. The amount of radiation to which the fluid is exposed is determined by factors such as: the proximity of the fluid to the lamps, the output wattage of the lamps, the fluid's flow rate past the lamps, the UV transmission (UVT) of the water or wastewater, the percent transmittance (%T) of the sleeves and the like. Typically, one or more UV sensors may be employed to monitor the UV output of the lamps and the fluid level is typically controlled, to some extent, downstream of the treatment device by means of level gates or the like.

However, disadvantages exist with the above-described systems. Depending upon the quality of the fluid which is being treated, the sleeves surrounding the UV lamps periodically become fouled with foreign materials, inhibiting the ability of the UV lamps to transmit UV radiation to the fluid. For a given installation, the occurrence of such fouling may be determined from historical operating data or by measurements from the UV sensors. Once, or before, fouling occurs, the sleeves should be cleaned to remove the fouling materials and optimize system performance.

If the UV lamp modules are employed in an open, channel-like system (e.g., such as the one described and illustrated in Maarschalkerweerd #1 Patents), one or more of the modules may be removed while the system continues to operate, and the removed frames may be immersed in a bath of suitable cleaning solution (e.g., a mild acid) which may be air-agitated to remove fouling materials. Of course, this necessitates the provision of surplus or redundant sources of UV radiation (usually by including extra UV lamp modules) to ensure adequate irradiation of the fluid being treated while one or more of the frames has been removed for cleaning. This required surplus UV capacity adds to the capital expense of installing the treatment system. Further, a cleaning vessel for receiving the UV lamp modules must also be provided and maintained. Depending on the number of modules which must be serviced for cleaning at one time and the frequency at which they require cleaning, this can also significantly add to the expense of operating and maintaining the treatment system. Furthermore, this cleaning regimen necessitates relatively high labor costs to attend to the required removal/re-installation of modules and removal/re-filling of cleaning solution in the cleaning vessel. Still further, such handling of the modules results in an increased risk of damage to or breakage of the lamps in the module.

If the frames are in a closed system (e.g., such as the treatment chamber described in U.S. Pat. No. 5,504,335 (in the name of Maarschalkerweerd and assigned to the assignee of the present invention) removal of the frames from the fluid for cleaning is usually impractical. In this case, the sleeves must be cleaned by suspending treatment of the fluid, shutting inlet and outlet valves to the treatment enclosure and filling the entire treatment enclosure with the cleaning solution and air-agitating the fluid to remove the fouling materials. Cleaning such closed systems suffers from the disadvantages that the treatment system must be stopped while cleaning proceeds and that a large quantity of cleaning solution must be employed to fill the treatment enclosure. An additional problem exists in that handling large quantities of cleaning fluid may be hazardous and disposing of large quantities of used cleaning fluid is difficult and/or expensive. Of course open flow systems suffer from these two problems, albeit to a lesser degree.

In light of the foregoing, it is not surprising that one of the largest maintenance costs incurred with installed prior art fluid treatment systems is often the cost of cleaning the sleeves about the radiation sources.

U.S. Pat. Nos. 5,418,370, 5,539,210, 5,590,390 and Re36,896 (all in the name of Maarschalkerweerd and all assigned to the assignee of the present invention and hereinafter referred to as the Maarschalkerweerd #2 Patents) all describe an improved cleaning system, particularly advantageous for use in gravity fed fluid treatment systems which employ UV radiation. Generally, the cleaning system comprises a cleaning sleeve engaging a portion of the exterior of a radiation source assembly including a radiation source (e.g., a UV lamp). The cleaning sleeve is movable between: (i) a retracted position wherein a first portion of radiation source assembly is exposed to a flow of fluid to be treated, and (ii) an extended position wherein the first portion of the radiation source assembly is completely or partially covered by the cleaning sleeve. The cleaning sleeve includes a chamber in contact with the first portion of the radiation source assembly. The chamber is supplied with a cleaning agent suitable for removing undesired materials from the first portion of the radiation source assembly.

In International publication number WO 00/26144 [Pearcey et al. (Pearcey)], published May 11, 2000, there is disclosed a cleaning apparatus for a radiation source module and a radiation source module incorporated such cleaning apparatus. Generally, the cleaning apparatus and related module comprise: (i) a slidable member magnetically coupled to a cleaning sleeve, the slidable member being disposed on and slidable with respect to a rodless cylinder; and (ii) motive means to translate the slidable member along the rodless cylinder whereby the cleaning sleeve is translated over the exterior of the radiation source assembly.

Further improvements to cleaning devices are described in:

International publication number WO 00/51943 [Traubenberg et al. (Traubenberg)], published Feb. 25, 2000;

International publication number WO 00/73213 [Dall'Armi et al. (Dall'Armi)], published May 26, 2000; and

International publication number WO 01/12560 [Fang et al. (Fang)], published Feb. 22, 2001; each assigned to the assignee of the present invention.

The teachings of Pearcey, Traubenberg, Dall'Armi and Fang each represent important advances in the art, particularly when implemented in a fluid treatment module such as the one illustrated in the Maarschalkerweerd #1 Patents. One area in the prior art which has received relatively little attention is the nature of the cleaning formulation used in such cleaning devices for optical radiation devices such as the ones taught in the Maarschalkerweerd #2 Patents and in Pearcey, Traubenberg, Dall'Armi and Fang.

It is known that the disinfection efficiency of a UV lamp is dependent on the cleanliness of the surface which houses the UV lamp—see Kreft, P.; Scheible, O. K.; Venosa, A. “HYDRAULIC STUDIES AND CLEANING EVALUATIONS OF ULTRAVIOLET DISINFECTION UNITS”, Journal WPCF, Volume 58, Number 12, p.1129 1986 [Kreft]. Cleaning of a ultraviolet disinfection system is important in order for the system to operate at optimum efficiency. Surface fouling can significantly affect the dose efficiency needed for meeting the disinfection requirements. Fused quartz sleeves, which are conventionally used to house the radiation lamps, are rated at an ultraviolet transmittance (UVT) of 80 to 90% when brand new. Maintaining the %UVT at or very close to 80% is highly desirable to sustain the ability to meet disinfection requirements.

Fouling on an ultraviolet radiation surface (e.g.,the quartz sleeve surrounding the lamp) is complex and can vary from site to site. The three main contributors to fouling include inorganic deposits, organic fouling and biofilms (which can grow when the surfaces are fouled and not fully irradiated)—see Kreft.

The major fouling components of inorganic scale deposits typically comprise one or more of magnesium hydroxide, iron hydroxide, calcium hydroxide, magnesium carbonate, calcium carbonate, magnesium phosphate and calcium phosphate. These are salts that possess inverse solubility characteristics—i.e., the solubility of salt decreases with increasing temperature. It has been indicated that quartz sleeves used in ultraviolet radiation systems such as the ones described above will have a higher temperature at the quartz/water interface than that of the bulk solution—see Kreft. This has led to the suggestion that fouling of such quartz sleeves may arise from the inverse solubility characteristics of the inorganic salts. Other factors such as surface photochemical effects may also lead to fouling.

A conventional method for cleaning inorganic fouled surfaces uses acidic materials. It should be noted that basic chemicals such as ammonium hydroxide or sodium hydroxide are usually avoided due to their chemical interaction with quartz and their limited cleaning efficacy of inorganic debris.

The magnitude of the cleaning ability of acids on inorganic media (inorganic fouling generally consists of metal oxides and carbonates on the quartz or other surface) is related primarily to pH. At low pH, metal cations aquate more easily and, in the important case of fouling by carbonate anions, decomposition via CO₂ formation occurs. Acids further have the ability to disrupt ion bridging effects that give rise to fouling films like soap scum and also to solubilize precipitated fatty acid soaps. In general, cleaning formulations use very strong acids to remove inorganic water spots, stains and encrustations on surfaces (McCoy, J. W. “Industrial Chemical Cleaning” Chapter 2, pp.34. Chemical Publishing Co. New York, N.Y.).

Wastewater treated by conventional ultraviolet radiation systems may also contain a wide variety of living organisms and organic-based molecules which include those that are surface active to oils and greases. Surface-active molecules, such as humic acids, which are negatively charged, can bind polyvalent ions (calcium, iron, magnesium) contained in the water. Additionally, because the surface active molecules contain hydrophobic moieties the adhesion of species that absorb ultraviolet radiation, such as proteins or aromatics, can also cause the transmission of the ultraviolet from the lamps to be reduced.

A number of chemicals have been suggested and used for cleaning scale deposits from surfaces with or without organic fouling materials. Inorganic acids such as hydrochloric acid, nitric acid, sulfuric acid, phosphoric acid and sulfamic acid are commonly used in the chemical cleaning of inorganic scale deposits—see Kreft. However, most of these acids are corrosive to the point where they require special handling procedures. Also, there is an increased likelihood of wear and tear on equipment as a consequence of using strong acids. Hydrochloric acid and sulfuric acid typically are not recommended in applications where exposure to stainless steel can occur due to their corrosive action. Nitric acid has oxidation capabilities and can only be used in a concentration of up to about 10% due to its potential reactivity. Phosphoric acid is a relatively safe and efficient cleaning acid, and is acceptable for use in the food and pharmaceutical industries.

In light of the foregoing, there exists an ongoing need for an improved cleaning formulation that as one or more of the following attributes:

(i) it can remove foreign deposits of organic, biological and inorganic origin from optical and/or metal surfaces;

(ii) it does not chemically interact substantially with the optical surface or leave residual adsorbed species which will substantially reduce the % UVT;

(iii) it is relatively safe to handle and is relatively non-corrosive to human skin;

(iv) it meets the current standards for governing environmentally acceptable usefulness in the wastewater and potable water industries;

(v) it maintains its cleaning activity over time (e.g., months) while being exposed to ultraviolet radiation;

(vi) it possesses preservative and/or anti-microbial properties;

(vii) it is substantially compatible with one or more other ingredients known in the art of cleaning formulations, including surfactants, wetting agents, thickeners, sequestrants and chelating agents;

(viii) it is substantially compatible for use in a wiper compartment and neither substantially degrades the seal material nor substantially retards wiper movement across a surface;

(ix) it is substantially useful in combination with thickeners that exhibit shear thinning properties in order to maintain control over its flow properties;

(x) it meets FDA guidelines for excipients or additives in food or drugs; and

(xi) it is not substantially corrosive toward stainless steel.

### SUMMARY OF THE INVENTION

It is an object of the present invention to provide a novel cleaning formulation which obviates or mitigates at least one of the disadvantages of the prior art.

It is another object of the present invention to provide a novel cleaning formulation for use with surfaces such as optical surfaces and metal surfaces.

It is another object of the invention to provide a method for improving and controlling the flow behaviour of the cleaning formulation.

It yet another object of the present invention to provide a method for removing fouling materials from an optical radiation surface.

Accordingly, in one of its aspects, the present invention provides a cleaning formulation for removing materials from a surface, the cleaning formulation comprising from about 0.5 to about 60 weight percent of a compound derived from urea and a phosphorus-containing acid, together with a carrier therefor.

In another of its aspects, the present invention provides a method for removing materials (e.g., fouling materials) from a surface comprising the step of application to the surface a cleaning formulation comprising from about 0.5 to about 60 weight percent of a compound derived from urea and a phosphorus-containing acid, together with a carrier therefor.

Thus, the present invention relates to the surprising and unexpected discovery that incorporation of a compound derived from urea and a phosphorus-containing acid into a formulation facilitates improved cleaning of a surface, such as an optical surface or a metal surface. Examples of optical surfaces which may be cleaned using the present formulation are not particularly restricted and include optical radiation surfaces (such as those described above, optical radiation sensor surfaces and the like), optical lens surfaces (such as a contact lens surface), metal surfaces and the like. The present formulation is very well suited for use in cleaning devices such as the ones described above.

### DETAILED DESCRIPTION OF THE PREFERRED EMBODIMENTS

Urea-phosphate is the reaction product of urea and phosphoric acid. This is the preferred compound for use in the present formulation and will be referred to throughout this specification. However, the present formulation also includes the use of a compound derived from urea and another phorphorus-containing acid, and thus it should be clearly understood that the present cleaning formulation may incorporate such a compound. Thus, non-limiting examples of suitable phosphorus-containing acids which can be combined with urea to form compounds useful in the present formulation may be selected from the group comprising orthophosphoric acid, isohypophosphoric acid, diphosphoric acid, triphosphoric acid, polyphosphoric acid (Hₙ₊₂PₙO₃ₙ₊₁; wherein n is up to about 17), cyclometaphosphoric acid (e.g., cyclotrimetaphosphoric acid, cyclotetrametaphosphoric acid and the like), polymetaphosphoric acids, phosphonic acid, alkylphosphonic acid, arylphosphonic acid, phosphinic acid, dialkylphosphinic acid, diaryl phosphinic acid, alkyl/aryl-phosphinic acids and mixtures thereof. As used throughout this specification, the term “alkyl” is intended to included C₁-C₁₀ alkyl groups and the term “aryl” is intended to include C₅-C₁₅ aryl groups. As stated above, the preferred phosphorus-containing acid is orthophosphoric acid (also referred to througout this specification as phosphoric acid).

Normally, the addition of even weak bases such as urea to strong acids leads to complex formation—strong acids protonate the weak bases forming salts that when dissolved in water act as buffer solutions. Crystal structures show these interactions: urea nitrate is a pure salt (Worsham, J. E., Jr.; Busing, W. R. Acta Cryst. 1969, B25, 572), urea-phosphate has the exchangeable proton equidistant between the urea and the phosphoric acid (Nozik, Yu. Z.; Fykin, I. E.; Bukin, V. I.; Muradyan, L. A. Kristallografiya 1976, 21, 7340, Kostansek, E. C.; Busing, W. R. Acta Cryst. B. 1972, 28, 2454), in urea oxalate, the proton remains associated with the oxalic acid (Kostansek, E.C.; Busing, W. R. Acta Cryst. C 1972, B28, 2454).

Based on this observation, one might have expected that urea-acid complexes would behave as buffers—that is, with the urea acting as a weak base. However, an examination of the pH profile of the complexes, when compared to the free acid, showed that urea does not affect the pH profile of phosphoric acid. Thus, urea behaves to moderate the corrosiveness of phosphoric acid, already a weak acid, without affecting the pKa.

The compound derived from urea and phosphorus containing acid which is useful in the present invention can be formed with any desired ratio of urea and phosphorus-containing acid that performs the desired function. Examples of suitable salts include those formed by combining urea and a phosphorus-containing acid (e.g., phosphoric acid, phosphonic acid, phosphinic acid, etc. as described above) in a molar ratio in the range of from about 1:1 and to about 1:4, preferably a molar ratio of from about 1:1 to about 1:2 (urea:phosphorus-containing acid).

The use of urea-phosphate (preferably derived from urea:phosphoric acid molar ratio of 1:1 to 1:4) to remove buildup of water insoluble metal salts on surfaces, to dissolve water-insoluble metal salt dispersions on surfaces, and to solubilize proteinaceous matter on surfaces has advantages over conventional methods using hydrochloric acid or phosphoric acid alone. For example, urea-hydrochloride is corrosive to metal equipment and therefore requires corrosion inhibitors and has the ability to release gaseous and aqueous hydrogen chloride. Mineral acids such as phosphoric acid require the addition of surface active agents and/or enzymes to solubilize compounds of organic and/or biological origin. Urea-phosphate has the ability to perform efficacious cleaning, without the need for additional surface active compounds, and remains mild to the surface being cleaned.

It is known to those in the art that the lower the pH, the more easily are the ions aquated in general, but the higher the pH, the better is the binding of metal ions either to adventitious or specifically added ligands. In accordance with the present invention, urea-phosphate, formed from the reaction between urea and a phosphorus-containing acid (preferably orthophosphoric acid), is used as an active ingredient to prepare cleaning chemical compositions. It advantageously balances these two requirements: keeping pH relatively low and keeping solvation of metals, via the urea, relatively high. Further, urea is a material that can mitigate biofouling, particularly by facilitating protein denaturation.

The urea-phosphate salt used in the present formulation effectively cleans both biofilms and inorganic foulants.

In practical terms, urea-phosphate offers further benefits. It is classified as a non-regulated, non-hazardous compound. This means it can be shipped dry and be reconstituted as an aqueous solution or gel/structured solution on site, saving shipping costs over aqueous acid solutions. Additionally, the constituents are not indicated on the NSF water guidelines as compounds of concern. It is, therefore, possible to directly use urea-phosphate in potable water applications.

In the preferred embodiment, urea is the only base. In the preferred embodiment, the cleaning formulation results from the combination of urea and phosphoric acid alone. In an alternative embodiment, the salt of a phosphorus-containing acid with urea or other weak base can be used in place of urea-phosphate if, when combined with a water insoluble metal salt, it produces a water soluble metal salt. Examples include mixtures of strong acids with, for example, alkanolamines, including triethanolamine, diethanolamine, monoethanolamine and HO—[(alkyl)O]ₓ—(CH₂)_{y}NH₂, including HO—[(CH₂)ₓO]—(CH₂)_{y}NH₂; wherein the alkyl group can vary within the moiety, wherein x is 1-8 (which can vary within the moiety) and y is an integer of 1 to 40; alkylamines, dialklylamines, trialkylamines, alklytetramines, polymers with amino or (alkyl or aryl) amino substituents groups, polymers with nitrogen-containing heterocyclic groups, acrylamide polymers and copolymers of acrylamide, vinyl pyrrolidone, polyvinyl pyrrolidone, copolymers of vinyl pyrrolidone, methacrylamide, polymethacrylamide, copolymers of acrylamide, and ammonia (which when combined with HCl forms ammonium chloride, which dissolves water-insoluble salts at a slow rate). Mixtures of these bases can also be used.

In accordance with a preferred embodiment of the present invention, urea-phosphate, formed from the reaction between urea and phosphoric acid, is used as an active ingredient to prepare cleaning chemical compositions which can be used with or without physical devices for cleaning applications for the removal of foreign matter deposited on surfaces such as optical surfaces and/or metal surfaces. Optionally, the urea-phosphate may be formulated with at least one surfactant to provide formulations which are non-streaking for particular applications not limited to the cleaning of fouled surfaces derived from wastewater and potable water applications. Additionally, the efficacy of cleaning is not diminished by the influence of UV irradiation. Although the urea-phosphate is the main active ingredient, several optional ingredients may also be used. Optional ingredients to enhance the cleaning efficacy include surfactants, builders, sequestrants, anti-fog polymers and thickeners.

Surfactants used in the formulations with urea-phosphate should be chosen such that they are stable in acidic conditions and have low foaming characteristics. Combinations of surfactants to provide synergistic effects are well know to those in the art. Additional surfactant properties include good stability in hard water, good biodegradability, good lubrication and have a neutral taste and odor. An example of a typical group of amphoteric surfactants for cleaning and rinse applications are the betaines. Typical non-limiting examples include the following betaines used in hard surface cleaning applications: capryl/capramidopropyl betaine, cocamidopropyl betaine and lauraamidipropyl betaine. Non-ionic surfactants encompassing ethoxylated alcohols, alkanol amide fatty acids, polyglycosides, carbamates and amine oxides are also well known in the cleaning art and may be used in the formulation. Polyglycosides are characterized by their excellent biodegradability and mildness. Typical examples of suitable glycosides for cleaning performance include caprylic/capric glycoside and lauryl glycoside. Amine oxides are commonly used in industrial cleaning applications and typical useful non-limiting examples include decylamine oxide, cocodimethylamine oxide, lauryldimethylamine oxide, myristyldimethylamine oxide, strearyldimethylamine oxide and cocamidopropylamine oxide. Anti-streak and anti-fog properties can also be incorporated into these cleaning formulations and typical silicone surfactants known in the art include those derived from polyether modified polysiloxanes.

Although urea-phosphate may be used as an aqueous solution to clean surfaces it may also be formulated into a gel or thickened state. In certain applications, it is preferred to deliver/utilize the cleaning formulation over extended periods of time, or to utilize the formulation such that it adheres to the fouled surface for longer life cleaning than would be possible by a simple aqueous solution. Both slow release formulation and improved adhesion to the fouled surface by the cleaner may be achieved if the cleaning solution is in the form of a shear thinning gel state. For instance, various of the Maarschalkerweerd and other patent properties mentioned above (and assigned to the assignee of the present application) describe cleaning solution chambers that are drawn across the surface of quartz tubes used in the disinfection of water to remove foulants. However, the time of exposure of the cleaning solution to quartz is exceptionally brief-gels adhere to the quartz and allow more time for efficacious cleaning. In applications that utilize a depot (e.g., a wiper compartment), from which the cleaning formula could inadvertently leak, the increased viscosity of such shear thinning solutions obviates or mitigates the leakage problems. Natural polymers such as guar gum, xanthan gum and welan gum can be used as satisfactory viscosity enhancing agents. Cellulosic polymers such as hydroxyethylcellulose, methylcellulose, hydroxypropylcellulose, carboxymethylcellulose can also be used. Gel formation may be achieved by using polyoxypropylene-polyoxyethylene block copolymers classified under the trademark Pluronic™ (BASF). The use of Pluronic™ F-127 is particularly useful when amounts of 10-20 wt/wt % are used. Natural and synthetic clays (e.g., bentonite, laponite, attapulgite and the like) and organoclay compositions (see, for example, the teachings of published European Patent Office application 0,245,474A) may be used as thickening agents in the present cleaning formulation.

The removal of metal salts from fouled surfaces is facilitated by low pH. It is further improved when ligands that can complex metals are present. Frequently, however, the binding efficiencies are much lower for ligands at low pH because the heteroatoms (e.g., O, N) that actually do the binding, are in the protonated form. However, some ligands continue to bind effectively to metals even at low pH. Organic phosphonic acids and their salts (i.e., phosphonates) are particularly effective sequestering agents and inhibitors of scale formation. As an example, Dequest™ 2010 (Monsanto) is particularly effective in complexing metal ions. In general phosphonic acids may be added to either the aqueous UP formulations to improve the rate of metal sequestration, and thus cleaning efficiency. They similarly do not have negative impact on the ability to form cleaning solutions that are thickened or gelled.

Polymer particles which are spherical, and have been shown in the art to be smooth enough to not scratch optical surfaces, include those derived from polyethylene, cellulose acetate butyrate, and Nylon-11. Ceramic particles may also be used and include those derived from silica-alumina and sold under the tradename Zeeospheres™ Microspheres (a registered trademark of 3M). These particles can be used to provide abrasive cleaning action when applied under shear to a surface. The addition of particles to thickened or gelled urea-phosphate solutions can provide additional mechanical based cleaning.

According to a preferred form of the present invention, the end product cleaning formulation will be aqueous based and be in the form of a solution, suspension or shear thinning fluid. The base composition will consist of urea-phosphate which will form 0.5 to 60 percent by weight of the total composition, a corrosion inhibitor (e.g., sodium benzoate and the like) which will form 0.1 to 10 percent weight of the total composition and a thickeners (e.g., one or more clays as described hereinabove) which will form 0.1 to 25 percent weight of the total composition. Optional ingredients such as scale inhibitors, sequestrants, surfactants, lubricants, polymer particles, wetting agents, biostatical agents, preservatives, buffering agents, anti-fouling agents and binders may also be incorporated into the formulations but this will depend on the end application.

The present cleaning formulation may be advantageously used in a number of applications where it is desired to remove fouling materials from a surface. In one embodiment, the present cleaning formulation may be disposed within the cleaning sleeve chamber of the cleaning system taught in the Maarschalkerweerd #2 Patents referred to above. In another embodiment, the present cleaning formulation may be disposed within a porous substrate (e.g., a sponge and the like) which is employed within the cleaning system of the Maarschalkerweerd #2 Patents, a different cleaning system or on its own.

Embodiments of the invention will be described with reference to the following Examples, which should not be used to construe or limit the invention.

### EXAMPLE 1

### Preparation of Urea:H₃PO₄

An efficient route to prepare a crystalline urea-phosphate product is the direct reaction between phosphoric acid (85%) and solid urea without a solvent. The process used is a modification of the one described in U.S. Pat. No. 3,936,501 [Freidinger et al.]. The reaction proceeds cleanly without the need for heating—sufficient heat is generated if produced by the exotherm of mixing the two ingredients.

This process was scaled up to 1500 g in one batch. To phosphoric acid (1050 g, 10 mol, 85%) was added urea (600 g, 10 mol). The mixture was stirred with a mechanical stirrer, at 30 rpm (paddle stirrer) without addition of heat. Initially, the urea prills floated on the surface. Eventually, the phosphoric acid appeared to wet the urea, the solution became increasingly turbid and an exotherm was observed.

After about 25 minutes, the temperature reached a maximum (about 75° C.) and the system became a very viscous paste. After about 1 hour, the “damp” highly viscous material was allowed to dry. The yield was 95% after 1 week drying at ambient temperature. 158 g of the urea-phosphate was diluted up to 1000 mL with water to give a 1 M solution. The solution was diluted as required.

### EXAMPLE 2

### Preparation of a Urea-phosphate Solution

Varying amounts of the urea-phosphate (prepared as in Example 1) were diluted up to 100 mL in a volumetric flask with Milli-Q water to give clear solutions. Table 1 provides the amounts of urea-phosphate used and the final pH of the solution.

TABLE 1

| Urea-phosphate (g) | pH |
|---|---|
| 7.5 | 1.1 |
| 16.1 | 0.93 |
| 25.0 | 0.83 |
| 35.0 | 0.70 |

### EXAMPLE 3

### Preparation of Salt of Urea and Phosphorus-containing Acid

To phosphoric acid (575 g, 85%) was added urea (300 g). The mixture was stirred with a Heidolph mechanical paddle stirrer at 350 rpm without addition of heat. Initially, the urea prills floated on the surface. Within a few minutes, the phosphoric acid wetted the urea and the reaction mixture became hot.

After about 25 minutes, the temperature reached a maximum (about 75° C.) and at this stage of the reaction 44 g of 1-hydroxyethylidene-1,1,-diphosphonic acid (Dequest™ 2010 Monsanto) was added quickly to the thickened slurry. After 10 minutes of further mixing at 350 rpm the slurry was removed from the mixer and the “damp” material was allowed to dry. The yield was 95% after 1week drying at ambient temperature.

### EXAMPLE 4

### Preparation of Solution of Salt of Urea and Phosphorus-containing Acid

Varying amounts of the salt prepare in Example 3 were diluted up to 100 mL in a volumetric flask with Milli-Q water to give clear solutions. Table 2 provides the amounts of urea-phosphate used and the final pH of the solution.

TABLE 2

| Urea-phosphate (g) | pH |
|---|---|
| 7.5 | 1 |
| 16.1 | 0.89 |
| 25.0 | 0.76 |
| 35.0 | 0.67 |

### EXAMPLE 5

### Preparation of a Urea-phosphate Gel

A 1M urea-phosphate solution was prepared using urea-phosphate produced in Example 1.

To 200 g of the urea-phosphate was added a pre-made slurry paste consisting of 4 g xanthan gum (Keltrol™, Kelco Biopolymers) and 30 g glycerol. This mixture was mixed with a 3-blade propeller at a speed of 700 rpm for 20 minutes. The viscosity of the mixture was determined to be 54000 mPa*s at a shear rate of 0.20 s⁻¹ using a Brookfield DVII+viscometer.

### EXAMPLE 6

### Evaluation of Cleaning Formulation

A 1M urea-phosphate solution was prepared using urea-phosphate produced in Example 1. To 200 g of the 1M urea-phosphate solution was added 1 g Pluronic™ F-127 (BASF) and after 10 minutes of mixing at 700 rpm using 3-blade propeller, a slurry mixture consisting of 2 g Xanthan (Keltrol™, Kelco Biopolymers) and 15 g glycerol was added. The mixture was mixed at speed of 500 rpm for 20 minutes. The viscosity of the final product was determined to be 22500 mPa*s at a shear rate of 0.20 s⁻¹ using a Brookfield DVII+viscometer.

A rapid screening protocol for evaluating the cleaning efficiency was used on a given fouled sleeve using urea-phosphate solutions. A cylindrical quartz tube was fouled in the following manner.

A cylindrical quartz tube (OD 2.5 cm) was fouled over one week using groundwater from Waterloo, Ontario Canada. During the fouling time, the UV lamp inside the tube was operating. A rapid screening protocol was used on a given fouled sleeve. 1 cm wide cylindrical domains (rings) of the fouled quartz cylindrical tube were segregated by conventional tape .

The 1 cm ring was exposed to a fixed volume of the cleaning formulation (2 mL) by use of a Pasteur pipette. While the entire cylindrical surface was coated (and then recoated within 60 sec with any formulation ‘run off’), mechanical cleaning by the pipette was avoided. After a total of 120 sec, the section was washed with deionized water (2×1 mL) and allowed to dry. The degree of fouling was established (using an unfouled part of the tube as an internal standard), using a UV spectrophotometer operating at 254. The beam was allowed to pass through both walls of the tube. The % Transmission of the region of interest was obtained. The higher the transmittance the better the cleaning efficacy of the cleaner. The results (Table 3) are given in terms of cleaning efficacy (in 2 min period) and cleaning rate (how fast the cleaner worked to return the transmittance to the original value of the “cleaned” sleeve, evaluated over a 30 min period). A scoring table of 0 to 4 was used with 4 being the highest score achievable.

TABLE 3

| Solution | Cleaning Efficacy | Cleaning Rate |
|---|---|---|
| Urea-phosphate | 4 | 3 |
| Urea-sulfate (0.5 M) | 4 | 1 |
| Phosphoric acid (0.5M) | 2 | 2 |
| Lime-Away ™ Cleaner* | 4 | 4 |

*A 3.8 M solution of phosphoric acid and other ingredients (e.g., surfactants, etc.)

The results in Table 3 illustrate that the urea-phosphate solution is more efficient than the urea-sulfate solution and the phosphoric acid solution. As shown, in order for phosphoric acid to achieve commensurate performance urea-phosphate, a significantly higher concentration of acid is needed (see results for Lime-Away™ Solution). As will be apparent from the above data, the cleaning composition in accordance with the present invention is very effective in removing inorganic matter on a surface. The data indicates that urea-phosphate at 1M concentration is an effective cleaning solution.

While the present invention has been described with reference to preferred and specifically illustrated embodiments, it will of course be understood by those skilled in the art that various modifications to these preferred and illustrated embodiments may be made without departing from the spirit and scope of the invention. For example, while the emphasis of the present application has been on urea-phosphate derived from urea and phosphoric acid, those of skill in the art will recognize that it is possible to use phosphonic acid or derivatives thereof. An example of such a phosphonic acid is 1-hydroxyethylidene-1,1 -diphosphonic acid, commercially available from Monsanto under to tradename Dequest 2010. Other phosphonic acids and derivatives thereof will be apparent to those of skill in the art. See, for example, U.S. Pat. No. 5,858,937 [Richard et al.].

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A cleaning formulation for removing materials from a surface, the cleaning formulation comprising from about 0.5 to about 60 weight percent of a compound derived from urea and a phosphorus-containing acid, together with a carrier therefor.

2. The cleaning formulation defined in claim 1, wherein the phosphorus-containing acid is selected from the group comprising orthophosphoric acid, isohypophosphoric acid, diphosphoric acid, triphosphoric acid, polyphosphoric acid, cyclometaphosphoric acid, polymetaphosphoric acids, phosphonic acid, alkylphosphonic acid, arylphosphonic acid, phosphinic acid, dialkylphosphinic acid, diaryl phosphinic acid, alkyl/aryl-phosphinic acids and mixtures thereof.

3. The cleaning formulation defined in claim 1, wherein the phosphorus-containing acid is selected from the group comprising orthophosphoric acid diphosphoric acid, polyphosphoric acid, phosphonic acid, phosphinic acid and mixtures thereof.

4. The cleaning formulation defined in claim 1, wherein the phosphorus-containing acid comprises orthophosphoric acid.

5. The cleaning formulation defined in claim 1, further comprising a surfactant.

6. The cleaning formulation defined in claim 5, wherein the surfactant comprises a non-ionic surfactant.

7. The cleaning formulation defined in claim 6, wherein the non-ionic surfactant comprises a member selected from the group consisting of ethoxylated alcohols, alkanol amide fatty acids, polyglycosides, carbamates, amine oxides and mixtures thereof.

8. The cleaning formulation defined in claim 5, wherein the surfactant comprises an amphoteric surfactant.

9. The cleaning formulation defined in claim 5, wherein the surfactant comprises at least one member selected from the group comprising amphoteric surfactants such as capryl/capramidopropyl betaine, cocamidopropyl betaine and lauramidopropyl betaine, non-ionic surfactants such as ethoxylated alcohols, alkanol amide fatty acids, polyglycosides, carbamates and amine oxides, polyglycosides such as caprylic/capric glycoside and lauryl glycoside and amine oxides such as decylamine oxide, cocodimethylamine oxide, lauryldimethylamine oxide, myristyldimethylamine oxide, strearyldimethylamine oxide and cocamidopropylamine oxide.

10. The cleaning formulation defined in claim 8, wherein the amphoteric surfactant comprises a betaine.

11. The cleaning formulation defined in claim 1, further comprising a polyether silicone.

12. The cleaning formulation defined in claim 1, further comprising a thickener.

13. The cleaning formulation defined in claim 12, wherein the thickener is selected from the group comprising polyethylene glycol, carboxy vinyl polymers, cellulose, hydroxyethylcellulose, methoxycellulose, hydroxyethylmethacrylate, polyvinyl alcohol, starch and mixtures thereof.

14. The cleaning formulation defined in claim 12, wherein the thickener comprises a member selected from the group comprising cross-linked acrylic polymers, alginates, carrageenan, organoclays, clays, guars, polyethylene oxide, polypropylene oxide/polyethylene oxide copolymers, polyvinyl pyrrolidone, polyvinyl alcohol, cellulosics such as carboxymethylcellulose and xanthan gum.

15. The cleaning formulation defined in claim 12, wherein the thickener is present in an amount of up to about 10 weight percent.

16. The cleaning formulation defined in claim 1, further comprising a sequestrant agent.

17. The cleaning formulation defined in claim 16, wherein the sequestrant agent is selected from group comprising silicates, citrates, phosphonates, phosphates and mixtures thereof.

18. The cleaning formulation defined in claim 1, wherein the compound is derived from a molar ratio of urea to phosphorus-containing acid in the range of from about 1:10 to 10:1.

19. The cleaning formulation defined in claim 1, wherein the molarity of the solution in urea is in the range of from about 0.05 to about 3M, and the molarity of the salt is in the range of from about 0.05 to about 5M.

20. The cleaning formulation defined in claim 1, further comprising a chelator.

21. The cleaning formulation defined in claim 1, further comprising a phosphorus-containing chelator.

22. The cleaning formulation defined in claim 20, wherein the chelator is selected from the group comprising phosphates, phosphonates and phosphites.

23. The cleaning formulation defined in claim 1, further comprising abrasive particles.

24. The cleaning formulation defined in claim 23, wherein the abrasive particles are selected from the group comprising polymer particles, such as those derived from: polyethylene; cellulose acetate butyrate; and Nylon-11, and ceramic particles, including those derived from silica, alumina or aluminosilicates.

25. A method for removing materials from a surface comprising the step of application to the surface a cleaning formulation comprising from about 0.5 to about 60 weight percent of a a compound derived from urea and a phosphorus-containing acid, together with a carrier therefor.

26. The method defined in claim 25, wherein the phosphorus-containing acid is selected from the group comprising orthophosphoric acid, isohypophosphoric acid, diphosphoric acid, triphosphoric acid, polyphosphoric acid, cyclometaphosphoric acid, polymetaphosphoric acids, phosphonic acid, alkylphosphonic acid, arylphosphonic acid, phosphinic acid, dialkylphosphinic acid, diaryl phosphinic acid, alkyl/aryl-phosphinic acids and mixtures thereof.

27. The method defined in claim 25, wherein the phosphorus-containing acid is selected from the group comprising orthophosphoric acid diphosphoric acid, polyphosphoric acid, phosphonic acid, phosphinic acid and mixtures thereof.

28. The method defined in claim 25, wherein the phosphorus-containing acid comprises orthophosphoric acid.

29. The method defined in claim 25, further comprising a surfactant.

30. The method defined in claim 29, wherein the surfactant comprises a non-ionic surfactant.

31. The method defined in claim 30, wherein the non-ionic surfactant comprises a member selected from the group consisting of ethoxylated alcohols, alkanol amide fatty acids, polyglycosides, carbamates, amine oxides and mixtures thereof.

32. The method defined in claim 29, wherein the surfactant comprises an amphoteric surfactant.

33. The method defined in claim 29, wherein the surfactant comprises at least one member selected from the group comprising amphoteric surfactants such as capryl/capramidopropyl betaine, cocamidopropyl betaine and lauramidopropyl betaine, non-ionic surfactants such as ethoxylated alcohols, alkanol amide fatty acids, polyglycosides, carbamates and amine oxides, polyglycosides such as caprylic/capric glycoside and lauryl glycoside and amine oxides such as decylamine oxide, cocodimethylamine oxide, lauryldimethylamine oxide, myristyldimethylamine oxide, strearyldimethylamine oxide and cocamidopropylamine oxide.

34. The method defined in claim 32, wherein the amphoteric surfactant comprises a betaine.

35. The method defined in claim 25, further comprising a polyether silicone.

36. The method defined in claim 25, further comprising a thickener.

37. The method defined in claim 36, wherein the thickener is selected from the group comprising polyethylene glycol, carboxy vinyl polymers, cellulose, hydroxyethylcellulose, methoxycellulose, hydroxyethylmethacrylate, polyvinyl alcohol, starch and mixtures thereof.

38. The method defined in claim 36, wherein the thickener comprises a member selected from the group comprising cross-linked acrylic polymers, alginates, carrageenan, organoclays, clays, guars, polyethylene oxide, polypropylene oxide/polyethylene oxide copolymers, polyvinyl pyrrolidone, polyvinyl alcohol, cellulosics such as carboxymethylcellulose and xanthan gum.

39. The method defined in claim 36, wherein the thickener is present in an amount of up to about 10 weight percent.

40. The method defined in claim 25, further comprising a sequestrant agent.

41. The method defined in claim 40, wherein the sequestrant agent is selected from group comprising silicates, citrates, phosphonates, phosphates and mixtures thereof.

42. The method defined in claim 25, wherein the compound is derived from a molar ratio of urea to phosphorus-containing acid in the range of from about 1:10 to 10:1.

43. The method defined in claim 25, wherein the molarity of the solution in urea is in the range of from about 0.05 to about 3M, and the molarity of the salt is in the range of from about 0.05 to about 5M.

44. The method defined in claim 25, further comprising a chelator.

45. The method defined in claim 25, further comprising a phosphorus-containing chelator.

46. The method defined in claim 44, wherein the chelator is selected from the group comprising phosphates, phosphonates and phosphites.

47. The method defined in claim 25, further comprising abrasive particles.

48. The method defined in claim 47, wherein the abrasive particles are selected from the group comprising polymer particles, such as those derived from: polyethylene; cellulose acetate butyrate; and Nylon-11, and ceramic particles, including those derived from silica, alumina or aluminosilicates.

49. The method defined in claim 25, wherein the surface comprises an optical surface.

50. The method defined in claim 25, wherein the surface comprises an optical radiation surface.

51. The method defined in claim 25, wherein the surface comprises an optical sensor surface.

52. The method defined in claim 25, wherein the surface comprises an optical lens surface.

53. The method defined in claim 52, wherein the optical lens surface comprises a contact lens.

54. The method defined in claim 25, wherein the surface comprises a metal surface.
